(19) United States
(12) Patent Application Publication
(10) Pub. No.: US 2012/0134169 A1
(43) Pub. Date: May 31, 2012

(54) LIGHT EMITTING DIODE LIGHT BOX AND LIGHTING ASSEMBLY USING THE SAME

(75) Inventors: Zhi-Ting Ye, Zaociao Township (TW); Kuo-Jui Huang, Taichung City (TW)

(73) Assignees: WINTEK CORPORATION, Taichung City (TW); WINTEK TECHNOLOGY(H.K) LTD., Dongguan City (CN)

(21) Appl. No.: 13/297,582

(22) Filed: Nov. 16, 2011

(30) Foreign Application Priority Data
Nov. 26, 2010 (TW) 99141119

(51) Int. Cl. F21V 8/00

(52) U.S. Cl. 362/555

(57) ABSTRACT

A light emitting diode (LED) light box including a housing, a first LED module and a light guiding block is provided. The housing has a first hole. The first LED module is disposed inside the housing. The light guiding block is disposed inside the housing and located in front of the first LED module and opposite to the first hole. The first light emitted by the first LED module enters and proceeds in the light guiding block and then passes through the first hole.

This application claims the benefit of Taiwan application Serial No. 99141119, filed Nov. 26, 2010, the subject matter of which is incorporated herein by reference.

### BACKGROUND OF THE INVENTION

1. Field of the Invention

The invention relates in general to an LED light box and a lighting assembly using the same, and more particularly to an LED light box capable of adjusting the outputted light and a lighting assembly using the same.

2. Description of the Related Art

The light emitted by the LED light box is normally centralized by a focusing lens first before the light is outputted from the light box, wherein the light is transmitted via gas medium. However, when the light is transmitted via gas medium, the light may be interfered with by gas molecules and become scattered. Consequently, energy loss occurs and the quality of the outputted light is affected. Moreover, due to the design of the LED light box, the luminous intensity or color of the light emitted by the conventional LED light box cannot be adjusted to fit users' needs. Thus, when different luminous intensities or lighting colors are required, several LED light boxes need to be provided. Therefore, how to provide an LED light box capable of reducing energy loss and satisfying various lighting requirements has come a prominent task for the industries.

### SUMMARY OF THE INVENTION

The invention is directed to an LED light box and a lighting assembly using the same. The outputted light is adjustable through the design of an LED module.

According to an aspect of the present invention, a light emitting diode (LED) light box including a housing, a first LED module and a light guiding block is provided. The housing has a first hole. The first LED module is disposed inside the housing. The light guiding block is disposed inside the housing and located in front of the first LED module and opposite to the first hole. The first light emitted by the first LED module enters and proceeds in the light guiding block and then passes through the first hole.

According to an alternative aspect of the present invention, a lighting assembly including an LED light box and a light conductor is provided. The LED light box includes a housing, a first LED module and a light guiding block. The housing has a first hole. The first LED module is disposed inside the housing. The light guiding block is disposed inside the housing and located in front of the first LED module and opposite to the first hole. The first light emitted by the first LED module enters and proceeds in the light guiding block and then passes through the first hole. The light conductor is disposed outside the housing, wherein one end of the light conductor is opposite to the first hole, so that the first light, after passing through the light guiding block, enters the light conductor and continues to be transmitted therein.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A shows a schematic diagram of an LED light box according to a first embodiment of the invention;

FIG. 1B shows a part of FIG. 1A;

FIG. 2 shows a schematic diagram of an LED light box according to a second embodiment of the invention;

FIG. 3 shows a schematic diagram of an LED light box according to a third embodiment of the invention; and

FIG. 4 shows a schematic diagram of a lighting assembly applying an embodiment of the invention.

### DETAILED DESCRIPTION OF THE INVENTION

### First Embodiment

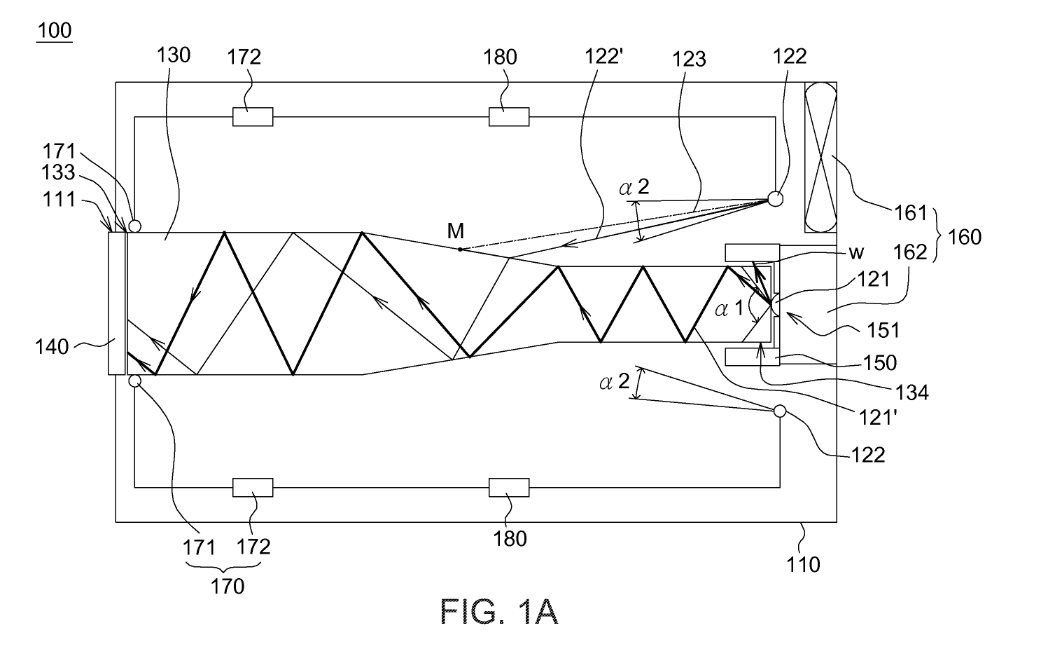

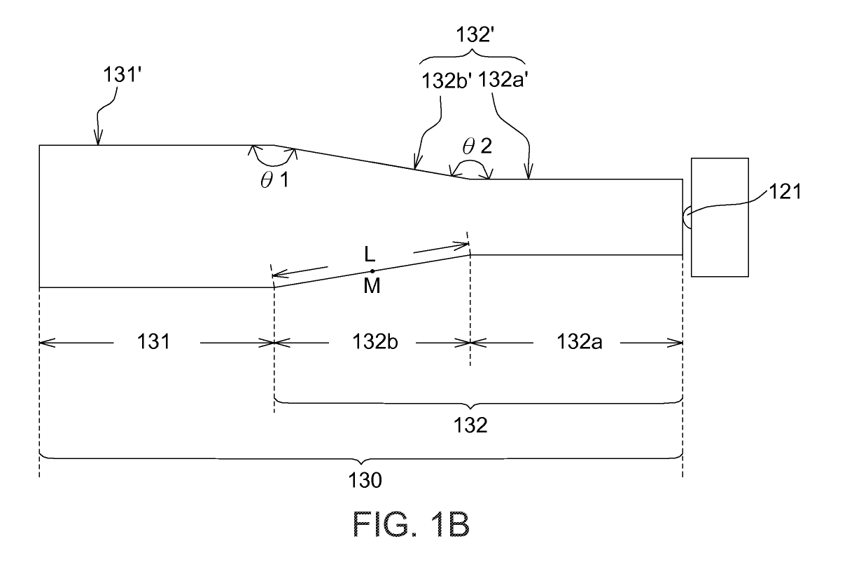

Referring to FIG. 1A, 1B. FIG. 1A shows a schematic diagram of an LED light box according to a first embodiment of the invention. FIG. 1B shows a part of FIG. 1A. The light emitting diode (LED) light box 100 includes a housing 110, an LED module 121 and a light guiding block 130. The housing 110 has a hole 111. The LED module 121 is disposed inside the housing 110. The light guiding block 130 is disposed inside the housing 110 and located in front of the LED module 121 and opposite to the hole 111. The light 121′ emitted by the LED module 121 enters and proceeds in the light guiding block 130 and then passes through the hole 111.

In the present embodiment of the invention, the LED module 121 can be realized by white light diodes or RGB light diodes. The LED module 121 emits a fan-shaped light having an angle defined as a light-pattern full angle α1 larger than a specific angle such as 100 degrees. The light-pattern is formed by many lights, and one of the many lights is designated as the light 121′. For convenience of elaboration in the present embodiment of the invention, the light 121′ represents the light transmitted in the light guiding block 130. As indicated in FIG. 1A, the light 121′ transmitted in the light guiding block 130 is totally reflected when reaching the edge of the light guiding block 130. In comparison to the conventional way of transmission of the light in gas medium, the light is transmitted in the light guiding block 130 by way of total reflection in the present embodiment of the invention, so that the energy loss of the light 121′ is largely reduced. The light guiding block 130 is a transparent light guiding block which can be formed by such as poly methyl methacrylate (PMMA), polycarbonate (PC), polyethylene terephthalate (PET) or glass. To make the illustration easier and simpler, FIG. 1A only shows the part of the moving path of the light 121′ in the light guiding block 130 but such exemplification does not mean that the light 121′ can only be transmitted in the light guiding block 130.

The design of the light guiding block 130 of the present embodiment of the invention is elaborated below. As indicated in FIG. 1B, the light guiding block 130 includes a light mixing region 131 and a light incoming region 132. The light mixing region 131 is located on one side of the light guiding block 130 away from the LED module 121. The light incoming region 132 is adjacent to the light mixing region 131 and adjacent to one side of the LED module 121. A lateral side 132′ of the light incoming region 132 and a lateral side 131′ of the light mixing region 131 are adjacent to each other and together form a contained angle θ1 ranging between 150˜165 degrees. In an alternative embodiment, the contained angle θ1 ranges between 0˜180 degrees.

The light incoming region 132 includes a front region 132a and a connection region 132b. The front region 132a is adjacent to one side of the LED module 121. The connection region 132b connects the light mixing region 131 and the front region 132a. The lateral side 132′ of the light incoming region 132 includes a lateral side 132a′ of the front region 132a and a lateral side 132b′ of the connection region 132b, which are adjacent to each other and together form a contained angle θ2 ranging between 150˜165 degrees. In an alternative embodiment, the contained angle θ2 ranges between 0˜180 degrees.

In the present embodiment of the invention, as indicated in FIG. 1A, the LED light box 100 further includes an LED module 122 disposed inside the housing 110. The LED module 122 can be realized by white light diodes or RGB light diodes, and the number of the LED module 122 can be one or many. In an embodiment, two LED modules 122 are symmetrically disposed on two sides of the LED module 121. The LED module 122 emits a fan-shaped light having an angle defined as a light-pattern full angle α2 (FIG. 1A) such as smaller than 80 degrees. Here, the LED module 122 is relative to the LED module 121, and the light-pattern full angle α2 of the LED module 122 is smaller than the light-pattern full angle α1 of the LED module 121. In other words, the LED module 122 belongs to the light beam centralization type, and the LED module 121 belongs to the light beam wide angle type. Besides, the power consumption of the LED module 122 is lower than that of the LED module 121, so that the LED module 122 generates less heat than the LED module 121. The LED module 122 emits a fan-shaped light formed by many lights, and one of the many lights is designated as the light 122′. For convenience of elaboration in the present embodiment of the invention, the light 122′ represents the light which not yet enters the light guiding block 130 and the light which is transmitted in the light guiding block 130. After the light 122′ enters the light guiding block 130 via the lateral side 132′ of the light incoming region 132, the light 122′ is transmitted to the light mixing region 131 in which the light 122′ and the light 121′ together form a mixed light which passes through the hole 111.

In greater details, the light 122′ emitted by the LED module 122 enters the light guiding block 130 via the lateral side 132b′ of the connection region 132b. The lateral side 132b′ of the connection region 132b has a length L. In the present embodiment of the invention, the lengths of all lateral sides 132b′ of the connection region 132b are the same, the length L of the lateral side 132b′ has a middle point M, and the angle bisector 123 of the light-pattern full angle α2 of the light 122′ emitted by the LED module 122 passes through the middle point M of the lateral side 132b′. In greater details, as indicated in FIGS. 1A and 1B, during the disposition of the LED module 122, the angle bisector 123 passes through the middle point M of the lateral side 132b′ of the connection region 132b of the light guiding block 130, so that the maximum light flux enters the light guiding block 130 via the lateral side 132b′, wherein the LED module 122 corresponds to the lateral side 132b′ of the connection region 132b. FIG. 1A only shows the part of the moving path of the light 122′ in the light guiding block 130 but such exemplification does not mean that the light 122′ can only be transmitted in the light guiding block 130. Besides, the lengths of the lateral sides 132b′ of the connection region 132b do not have to be the same, and in practical application, the lengths can be designed to be different to fit users' different needs.

The effects of the LED module 122 are elaborated below. The LED module 121 of the LED light box 100 is the primary light emitting element. In the present embodiment of the invention, through the disposition of the LED module 122 and the adjustment in the luminous intensity or lighting color of the LED module 122, the outputted light of the LED light box 100 is more versatile. For example, in terms of the intensity of the light source, the luminous intensity of the LED module 122 can be increased to achieve the desired luminance if the luminance of the outputted light is too low, and the luminous intensity can be decreased if the luminance is too high. Also, the lighting color of the LED module 122 can be adjusted, so that in the light mixing region 131, the outputted light 122′ is mixed with the light 121′ emitted by the LED module 121 to achieve the default average color rendering index (Ra). Besides, the number of the LED module 122 is not limited to be two exemplified in FIG. 1A. In an application example, the number of the LED modules 122 can be one or more than one, and the luminous intensity or lighting color of the LED module 122 can be adjusted according to the design.

In the present embodiment of the invention, the LED light box 100 further includes a sleeve 150 having a hole 151 for receiving the LED module 121, wherein the hole 151 is located at the center of the bottom of the sleeve 150. The sleeve 150 covers one end 134 of the light guiding block 130 at which the LED module 121 is disposed to avoid the light 121′ being leaked via the end 134. For example, the sleeve 150 avoids the occurrence of stray light, which leads to discrepancies in specification and occurs when the light-pattern full angle α1 of the light 121′ emitted by the LED module 121 is too large (such as larger than 100 degrees) or when the LED module 121 is displaced by an external force, so that a part of the light 121′ is transmitted to the edge of the light guiding block 130 at a smaller incident angle. Since smaller incident angle cannot make the light 121′ reach the edge of the light guiding block 130 to generate total reflection, the light 121′ is transmitted to the exterior of the light guiding block 130 and becomes a stray light. As indicated in FIG. 1A, when the light w (that is, the light emitted by the LED module 121 that is deviated to too large an angle) is transmitted to the exterior of the light guiding block 130, the light w is blocked by the sleeve 150 and will not become a stray light. In the design of an application, if the LED module 121 with a suitable light-pattern full angle is selected, the sleeve 150 can be omitted, and detailed descriptions are disclosed in the third embodiment.

In the present embodiment of the invention, the LED light box 100 is a high-power lighting module and further includes a heat dissipating portion 160 disposed on the LED module 121. The heat dissipating portion 160 includes a fan 161 and a heat dissipating element 162. As indicated in FIG. 1A, the heat dissipating element 162 is attached on the LED module 121. The heat generated by the LED module 121 is transmitted to the heat dissipating element 162 first, and then the heat on the heat dissipating element 162 is dissipated through air convection generated by the fan 161 so that the temperature is reduced. Since the power of the LED module 122 is lower than that of the LED module 121, there is no need to dispose a heat dissipating portion on the LED module 122 in the present embodiment of the invention. In an application example, if the LED module 122 adopts a high-power lighting module or other application design, then a heat dissipating portion can be disposed on the LED module 122.

In the present embodiment of the invention, the LED light box 100 further includes a light filter 140 located at one end 133 of the light guiding block 130, wherein the end 133 is adjacent to the hole 111 of the housing 110. The light filter 140 is disposed on the hole 111, so that the light passes through the light filter 140 to obtain the predetermined optical properties before being emitted by the LED light box 100.

The LED light box 100 further includes a feedback module 170 and a control module 180. The feedback module 170 is electrically connected to the control module 180 for detecting the light 121′ or the mixed light of the light 121′ and light 122′ that passes through the light guiding block 130 to generate a signal accordingly. The control module 180 receives the signal, and selectively controls the light emitting state of the LED module 121 or the LED module 122 according to the received signal. In the present embodiment of the invention, the feedback module 170 includes a detector 171 and a reception module 172. The detector 171 is disposed at one end 133 of the light guiding block 130 adjacent to the hole 111 of the housing 110 for sensing the light 121′ or the mixed light of the light 121′ and light 122′ that passes through the end 133 to generate a signal accordingly. The reception module 172 is electrically connected to the detector 171 for receiving the signal. The control module 180 electrically connected to the reception module 172 receives a signal from the reception module 172 and then selectively controls the LED module 122 according to the received signal. In an application example, after the reception module 172 receives a signal, the reception module 172 selectively controls the LED module 121 or concurrently controls the LED module 121 and the LED module 122.

### Second Embodiment

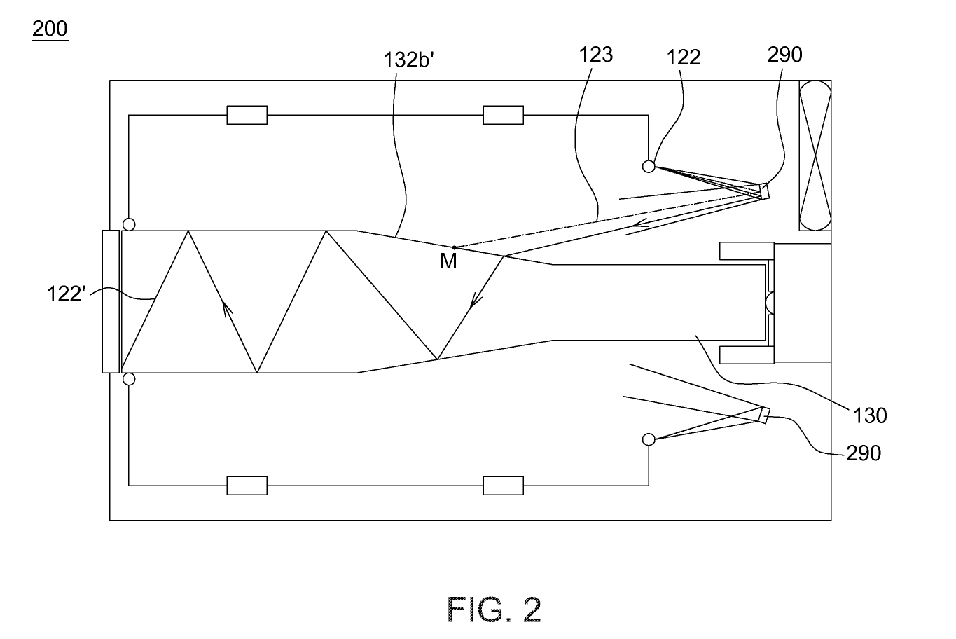

Referring to FIG. 2, a schematic diagram of an LED light box according to a second embodiment of the invention is shown. The present embodiment of the invention is different from the first embodiment in that the LED light box 200 further includes a reflector 290, so that the light 122′ emitted by the LED module 122 is reflected by the reflector 290 first and then enters the light guiding block 130. After the angle bisector 123 of the LED module 122 reaches the reflector 290, the moving path of the reflective light passes through the middle point M of the lateral side 132b′. The reflector 290 can be realized by a mirror or formed by a material with high reflectance. Other parts of the present embodiment of the invention are similar to the first embodiment, and the similarities are not repeated here. FIG. 2 only shows the part of the moving path of the light 122′ in the light guiding block 130. However, such exemplification does not mean that the light of the LED light box 200 is limited to the light 122′ or the light can only be transmitted in the light guiding block 130. The remaining elements of the present embodiment of the invention are similar to that of the first embodiment, and the similarities are not repeated here.

### Third Embodiment

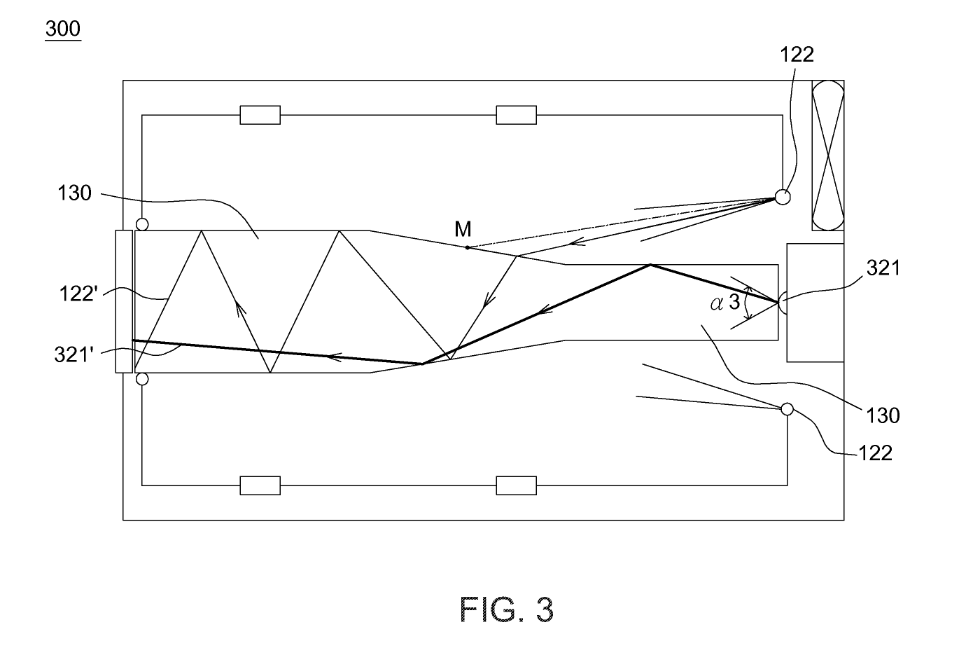

Referring to FIG. 3, a schematic diagram of an LED light box according to a third embodiment of the invention is shown. The present embodiment of the invention is different from the first embodiment in that the light beam wide angle type LED module 121 of the first embodiment is replaced by the light beam centralization LED module 321, and the sleeve 150 of the first embodiment is omitted. As indicated in FIG. 3, the LED module 321 emits a fan-shaped light having an angle defined as the light-pattern full angle α3 substantially smaller than 80 degrees for example. The light-pattern formed by many lights, and one of the many lights is designated as the light 321′. For convenience of elaboration in the present embodiment of the invention, the light 321′ represents the light emitted by the LED module 321 and transmitted in the light guiding block 130.

The sleeve 150 of the first embodiment is omitted in the third embodiment. In comparison to the light emitted by the LED module 121 of the first embodiment, the light emitted by the LED module 321 of the present embodiment of the invention is more centralized, and the light 321′ emitted by the LED module 321 is transmitted to the edge of the light guiding block 130 at a larger incident angle. Thus, the light 321′ mostly proceeds in a manner of total reflection, and will not be leaked to the exterior of the light guiding block 130 and become a stray light. As the LED module 321 with a smaller light-pattern full angle α3 is adopted according to the third embodiment, the light 321′ will not be leaked to the exterior of the light guiding block 130, the sleeve 150 of the first embodiment is omitted, and the cost is reduced without affecting the luminous effect of the LED light box. The remaining elements of the present embodiment of the invention are similar to that of the first embodiment, and the similarities are not repeated here.

### Application Example

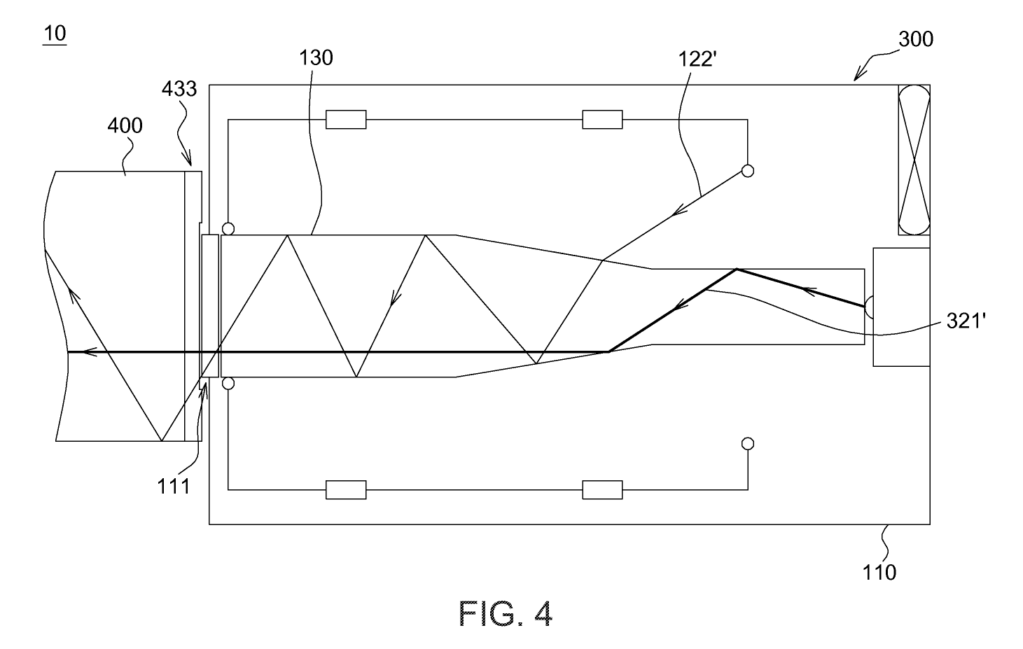

In an application example, the LED light box can be applied in a lighting assembly. Referring to FIG. 4, a schematic diagram of a lighting assembly applying an embodiment of the invention is shown. The lighting assembly 10 includes an LED light box 300 and a light conductor 400. The light conductor 400 is disposed outside the housing 110 and one end 433 of the light conductor 400 is opposite to the hole 111, so that the light 321′ and the light 122′, after passing through the light guiding block 130, enter the light conductor 400 and continue to be transmitted therein. The light conductor 400 can be formed by optical fibers. The LED light box 300 of the lighting assembly 10 of the application example can be replaced by the LED light box 100 of the first embodiment or the LED light box 200 of the second embodiment.

An LED light box and a lighting assembly using the same are disclosed in the above embodiments of the invention. Unlike the conventional transmission of the light through gas medium which incurs a large amount of energy loss, the light conductor is used as the transmission medium e of the light according to the embodiments of the invention. Thus, the light can be transmitted in the manner of total reflection through a non-gas medium, the energy loss of the light is reduced and the intensity of the light is maintained. By using the LED module 121 as the primary light emitting element and matching the lateral side of the light guiding block with the disposition of the LED module 122, the light emitted by the LED module 122 can enter the light guiding block via the lateral side of the light guiding block. Thus, through the adjustment in the luminous intensity or lighting color of the LED module 122, the light emitted by the LED module 121 and the light emitted by the LED module 122 can be mixed as a mixed light in a light mixing region. Thus, the LED module 122 is an auxiliary element for mixing the light to achieve the desired intensity or lighting color of the light to fit users' different needs in various occasions.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting diode (LED) light box, comprising:
a housing having a first hole;
a first light emitting diode (LED) module disposed inside the housing for emitting a first light; and
a light guiding block disposed inside the housing and located in front of the first LED module and opposite to the first hole.

2. The LED light box according to claim 1, wherein the light guiding block comprises:
a light mixing region located one side of the light guiding block away from the first LED module; and
a light incoming region adjacent to the light mixing region and adjacent to one side of the first LED module, wherein a first specific contained angle is contained between a lateral side of the light incoming region and a lateral side of the light mixing region adjacent to the light incoming region, and the first specific contained angle ranging between 0˜180 degrees.

3. The LED light box according to claim 2, further comprising a second LED module disposed inside the housing for emitting a second light, wherein the second light enters the light guiding block via the lateral side of the light incoming region and reaches the light mixing region, and then the second light and the first light form a mixed light, which passes through the first hole.

4. The LED light box according to claim 3, wherein the light incoming region comprises:
a front region adjacent to one side of the first LED module; and
a connection region connecting the light mixing region and the front region, wherein the lateral side of the light incoming region comprises a lateral side of the front region and a lateral side of the connection region, and a second specific contained angle is contained between the lateral side of the front region and the lateral side of the connection region adjacent to the front region, and the second specific contained angle ranging between 0˜180 degrees.

5. The LED light box according to claim 4, wherein the lateral side of the connection region has a length with a middle point, the angle bisector of the light-pattern full angle of the second light passes through the middle point, and the second specific contained angle ranges between 150˜165 degrees.

6. The LED light box according to claim 3, further comprising a reflector for reflecting the second light to enter the light guiding block, wherein the light-pattern full angle of the second light is smaller than 80 degrees.

7. The LED light box according to claim 3, further comprising a feedback module and a control module, wherein the feedback module is electrically connected to the control module for detecting the mixed light passing through the light guiding block and generating a signal accordingly, and the control module receives the signal and selectively controls the light emitting state of the first LED module or the second LED module according to the received signal.

8. The LED light box according to claim 2, wherein the first specific contained angle ranges between 150˜165 degrees.

9. The LED light box according to claim 1, further comprising a sleeve having a second hole for receiving the first LED module, wherein the sleeve covers one end of the light guiding block to avoid the first light being leaked via the end, and the light-pattern full angle of the first light is larger than 100 degrees.

10. The LED light box according to claim 1, further comprising a heat dissipating portion disposed on the first LED module.

11. The LED light box according to claim 1, further comprising a light filter located at one end of the light guiding block, wherein the end is adjacent to the first hole.

12. A lighting assembly, comprising:
an LED light box, comprising:
a housing having a first hole;
a first light emitting diode (LED) module disposed inside the housing for emitting a first light; and
a light guiding block disposed inside the housing and located in front of the first LED module and opposite to the first hole; and
a light conductor disposed outside the housing, wherein one end of the light conductor is opposite to the first hole, so that the first light, after passing through the light guiding block, enters the light conductor and then continues to be transmitted therein.
